(19) United States
(12) Patent Application Publication
(10) Pub. No.: US 2024/0299993 A1
(43) Pub. Date: Sep. 12, 2024

(54) PIPE CLEARING TOOL WITH OVER-PRESSURE PROTECTED AUTOMATIC SEAL

(71) Applicant: Anthony Hollars, Tucson, AZ (US)

(72) Inventor: Anthony Hollars, Tucson, AZ (US)

(21) Appl. No.: 18/597,129

(22) Filed: Mar. 6, 2024

Related U.S. Application Data
(60) Provisional application No. 63/488,527, filed on Mar. 6, 2023.

(51) Int. Cl. B08B 9/032

(52) U.S. Cl. CPC B08B 9/0321

(57) ABSTRACT

A pipe clearing tool with over-pressure protected automatic seal is disclosed.

### FIELD OF THE INVENTION

A pipe clearing tool with over-pressure protected automatic seal is disclosed.

### BACKGROUND OF THE INVENTION

There have been many unsuccessful attempts to create an expanding pipe clearing tool that allows pressurized gas or liquid to pass through the tool to clear the pipe downstream. These prior art devices all comprise a passage through the device that allows the flow to pass through without any means to restrict it other than the orifice size at the exit end. Theses prior art devices are replete with problems. For example, these prior art devices can explode if the flow or pressure of the gas or liquid is restricted by too small an exit orifice. The internal pressure may exceed the strength of the bladder material. Also, if they are inflated outside the limiting diameter of the pipe they can explode. Moreover, if the flow or pressure is not sufficient, then the prior art devices won't inflate.

### BRIEF DESCRIPTION OF THE DRAWINGS

The invention will be better understood from a reading of the following detailed description taken in conjunction with the drawings in which like reference designators are used to designate like elements, and in which:

FIG. 1 comprises a cross-sectional internal view of Applicant's pipe clearing tool;

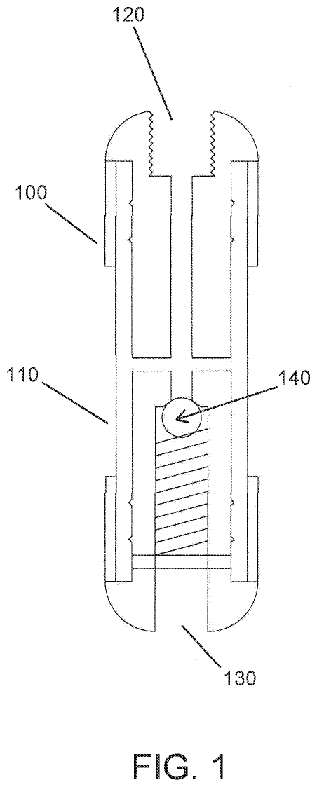

FIG. 2 illustrates the exterior of Applicant's pipe clearing tool; and

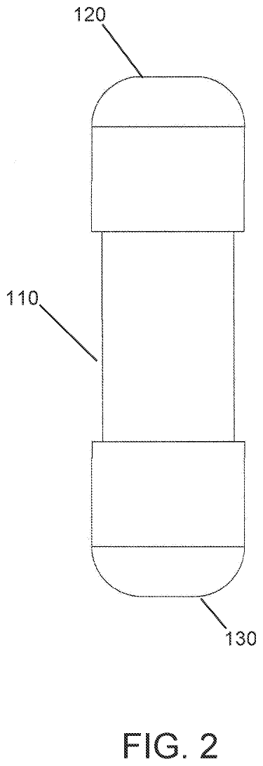

FIG. 3 illustrates a cross-sectional view of Applicant's pipe clearing tool wherein the tubular elastomers is inflated.

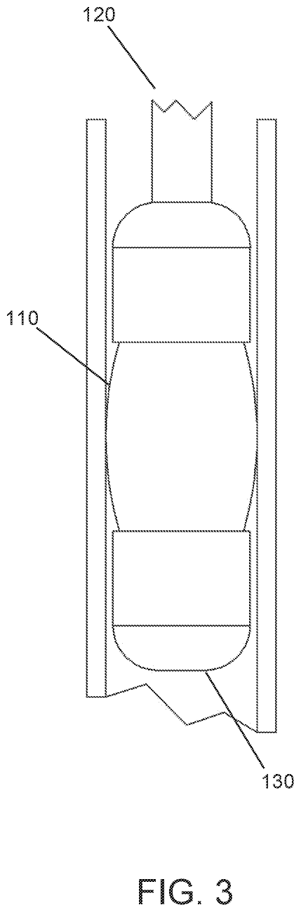

### DESCRIPTION OF THE PREFERRED EMBODIMENTS

The described features, structures, or characteristics of Applicant's disclosure may be combined in any suitable manner in one or more embodiments. In the following description, numerous specific details are recited to provide a thorough understanding of embodiments of the invention. One skilled in the relevant art will recognize, however, that Applicant's disclosure may be practiced without one or more of the specific details, or with other methods, components, materials, and so forth. In other instances, well-known structures, materials, or operations are not shown or described in detail to avoid obscuring aspects of Applicant's disclosure, and it will be appreciated by those skilled in the art that it is intended to cover alternatives, modifications, and equivalents as may be included within the spirit and scope of Applicant's disclosure as defined by the appended claims and their equivalents as supported by the following disclosure and drawings.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention, and it will be appreciated by those skilled in the art that it is intended to cover alternatives, modifications, and equivalents as may be included within the spirit and scope of the invention as defined by the appended claims and their equivalents as supported by the following disclosure and drawings.

I claim:

1. A pipe and drain clearing tool 100 comprising:
a tubular elastomer 110 comprising an outside diameter, a first end, and a second end, said tubular elastomers being capable of being inflated with pressurized fluid when closed at both ends;
an input end 120 in fluid communication with said first end;
a normally closed ball valve 140 in fluid communication with said second end;
wherein:
a. said ball valve comprises a release pressure which causes said ball valve to open;
b. said tool may be inserted into a clogged pipe having an internal diameter greater than said tool outside diameter;
c. when said pressurized fluid is first introduced into said tool via said input end, said ball valve remains closed causing the tubular elastomers to expand to said pipe inside diameter and thereby seal the device in the pipe;
d. thereafter additional pressurized is introduced into the tool thereby increasing the internal pressure inside the now inflated elastomer;
e. when the internal pressure inside the elastomers exceeds the release pressure of the ball valve, the tool then delivers the full flow of the pressurized fluid out the discharge end 130 and downstream to clear the clogged pipe.
